(19) United States
(12) Patent Application Publication
(10) Pub. No.: US 2012/0217765 A1
(43) Pub. Date: Aug. 30, 2012

(54) PORTABLE PRIVACY BARRIER FOR A MOTOR VEHICLE

(76) Inventors: Catherine M. Michael, Indianapolis, IN (US); Jeffrey A. Michael, Indianapolis, IN (US)

(21) Appl. No.: 13/371,618

(22) Filed: Feb. 13, 2012

Related U.S. Application Data
(60) Provisional application No. 61/463,052, filed on Feb. 11, 2011.

(51) Int. Cl. B60N 3/00

(52) U.S. Cl. 296/24.46

(57) ABSTRACT

A portable privacy barrier is positionable between two side-by-side motor vehicle seats or between two portions of a single, multiple occupant motor vehicle seat. A first elongated support member is configured to be removably secured between a floor and a ceiling of the motor vehicle fore of the seat or seats, and a second elongated support member configured to be removably secured between the ceiling of the motor vehicle and the floor of the motor vehicle aft of the two seats or between the ceiling of the motor vehicle and the seat bottom of the single seat. A flexible sheet is attached to the first and second elongated support members and extends between the first and second elongated support members to provide the privacy barrier.

### CROSS-REFERENCE TO RELATED APPLICATION

This application claims the benefit of, and priority to, U.S. Provisional Patent Application Ser. No. 61/463,052, filed Feb. 11, 2011, the disclosure of which is incorporated herein by reference.

### FIELD OF THE INVENTION

The present invention relates generally to barriers for providing privacy between at least two occupants of a motor vehicle, and more specifically to such barriers that are portable and storable within the motor vehicle when not deployed.

### BACKGROUND

It is desirable to provide for visual privacy between occupants of side-by-side motor vehicle seats or between two or more occupants of a single, multiple occupant motor vehicle seat.

### SUMMARY

The present invention may comprise one or more of the features recited in the attached claims, and/or one or more of the following features and combinations thereof. In one example embodiment, a portable privacy barrier is provided for a motor vehicle having two separate occupant seats positioned side-by-side with a gap defined therebetween. In this embodiment, the privacy barrier may comprise a first elongated support member configured to be removably secured between a floor and a ceiling of the motor vehicle fore of the two separate occupant seats, a second elongated support member configured to be removably secured between the floor and the ceiling of the motor vehicle aft of the two separate occupant seats, and a flexible sheet having a first end attached to the first elongated support member and a second opposite end attached to the second elongated support member, the flexible sheet extending between the first and second elongated support members and through the gap between the two separate occupant seats to provide a privacy barrier between the two separate occupant seats.

The flexible sheet may define a fully extended width between the first and second ends thereof, and the flexible sheet and the first and second elongated support members may be configured such that the flexible sheet wraps at least partially around either or both of the first and second elongated support members any number of times to define a deployed width of the flexible sheet between the first and second elongated support members and between the two separate occupant seats that is less than the fully extended width.

The flexible sheet may define a top end extending between the first and second ends of the flexible, and the top end may be positioned between tops of the two separate occupant seats and the ceiling of the motor vehicle. Illustratively, the top end extending between the first and second ends of the flexible sheet may be positioned at or near the ceiling of the motor vehicle.

The flexible sheet may define a bottom end extending between the first and second ends of the flexible sheet, and the bottom end may be positioned between seat portions of the two separate occupant seats and the floor of the motor vehicle. Illustratively, the bottom end extending between the first and second ends of the flexible sheet may be positioned at or near the floor of the motor vehicle.

The first end of the flexible sheet may be attached to the first elongated support member at least partially along a length of the first elongated support member, and the second end of the flexible sheet may be attached to the second elongated support member at least partially along a length of the second elongated support member. The first end of the flexible may define a first closed channel at least partially along the length of the first end of the flexible sheet, and the first closed channel may be sized to receive therein the first elongated support member. The second end of the flexible sheet may define a second closed channel at least partially along the length of the second end of the flexible sheet, and the second closed channel may be sized to receive therein the second elongated support member.

The first elongated support member may comprise a first linear member and a second linear member received within the first linear member, and the first and second linear members may be movable relative to each other to modify a length of the first elongated support member. The second elongated support member may comprise a third linear member and a fourth linear member received within the third linear member, and the third and fourth linear members may be movable relative to each other to modify a length of the second elongated support member.

The portable privacy barrier may further comprise a first base positioned between a top end of the first elongated support member and the ceiling of the motor vehicle. The first base may have a first contact surface that contacts the ceiling of the motor vehicle, and the first contact surface may be sized to distribute a force applied by the first elongated support member to the ceiling of the motor vehicle over a sufficiently large area of the ceiling of the motor vehicle to inhibit permanent deformation of a surface of the ceiling by the first elongated support member. The portable privacy barrier may further comprise a second base positioned between a top end of the second elongated support member and the ceiling of the motor vehicle. The second base may have a second contact surface that contacts the ceiling of the motor vehicle, and the second contact surface may be sized to distribute a force applied by the second elongated support member to the ceiling of the motor vehicle over a sufficiently large area of the ceiling of the motor vehicle to inhibit permanent deformation of a surface of the ceiling by the second elongated support member.

The flexible sheet may comprise at least one pocket on at least one side thereof. Alternatively or additionally, the flexible sheet may comprise one or more straps affixed to at least one side thereof.

The first and second elongated support members may each be configured to be disassembled. The portable privacy barrier may further comprise a storage bag sized to receive therein the disassembled first and second elongated support members and the flexible sheet, and the storage bag may be sized for storage within the motor vehicle with the disassembled first and second elongated support members and the flexible sheet stored therein.

In another example embodiment, a portable privacy barrier is provided for a single, multiple occupant seat of a motor vehicle, wherein the occupant seat has a seat back, a seat bottom and a bight defined between the seat back and the seat bottom. In this embodiment, the privacy barrier may comprise a first elongated support member configured to be removably secured between a floor and a ceiling of the motor vehicle fore of the single, multiple occupant seat, a second elongated support member configured to be removably secured between the ceiling of the motor vehicle and the seat bottom adjacent to the bight, and a flexible sheet having a first end attached to the first elongated support member and a second opposite end attached to the second elongated support member, the flexible sheet extending between the first and second elongated support members and across the single, multiple occupant motor vehicle seat to provide a privacy barrier between two portions of the single, multiple occupant motor vehicle seat.

The flexible sheet may define a fully extended width between the first and second ends thereof, and the flexible sheet and the first and second elongated support members may be configured such that the flexible sheet wraps at least partially around either or both of the first and second elongated support members any number of times to define a deployed width of the flexible sheet between the first and second elongated support members and across the single, multiple occupant motor vehicle seat that is less than the fully extended width.

The flexible sheet may define a bottom end extending between the first and second ends of the flexible sheet, and the bottom end of the flexible sheet may comprise a first portion positioned at or near an occupant support surface of the seat bottom and a second portion positioned at or near the floor of the motor vehicle fore of the single, multiple occupant vehicle seat.

The first elongated support member may comprise a first linear member and a second linear member received within the first linear member, and the first and second linear members may be movable relative to each other to modify a length of the first elongated support member. The second elongated support member may comprise a third linear member and a fourth linear member received within the third linear member, and the third and fourth linear members may be movable relative to each other to modify a length of the second elongated support member.

The portable privacy barrier may further comprise a first base positioned between a top end of the first elongated support member and the ceiling of the motor vehicle. The first base may have a first contact surface that contacts the ceiling of the motor vehicle, and the first contact surface may be sized to distribute a force applied by the first elongated support member to the ceiling of the motor vehicle over a sufficiently large area of the ceiling of the motor vehicle to inhibit permanent deformation of a surface of the ceiling by the first elongated support member. A second base may be positioned between a top end of the second elongated support member and the ceiling of the motor vehicle, and the second base may have a second contact surface that contacts the ceiling of the motor vehicle. The second contact surface may be sized to distribute a force applied by the second elongated support member to the ceiling of the motor vehicle over a sufficiently large area of the ceiling of the motor vehicle to inhibit permanent deformation of a surface of the ceiling by the second elongated support member.

The flexible sheet may comprise one of at least one pocket on and at least one strap affixed to at least one side thereof. Alternatively or additionally, the flexible sheet may comprise one or more straps affixed to at least one side thereof.

In a motor vehicle having two separate occupant seats positioned side-by-side with a gap defined therebetween, a method of forming a privacy barrier between the two separate occupant seats may comprise securing a first elongated support member between a floor and a ceiling of the motor vehicle fore of the two separate occupant seats, securing a second elongated support member between the floor and the ceiling of the motor vehicle aft of the two separate occupant seats, attaching one end of a flexible sheet to the first elongated support member and an opposite end of the flexible sheet to the second elongated support member such that the flexible sheet extends through the gap between the two separate occupant seats, wrapping at least one of the one end of the flexible sheet at least partially around the first elongated support member and the opposite end of the flexible sheet at least partially around the second elongated support member to define a deployed width of the flexible sheet between the two separate occupant seats that is less than a fully extended width of the sheet defined between the one and the opposite end thereof.

In a motor vehicle having a single, multiple occupant seat having a seat back, a seat bottom and a bight defined between the seat back and the seat bottom, a method of forming a privacy barrier between two portions of the occupant seat may comprise securing a first elongated support member between a floor and a ceiling of the motor vehicle fore of the occupant seat, securing a second elongated support member between the ceiling of the motor vehicle and the seat bottom of the occupant seat adjacent to the bight, attaching one end of a flexible sheet to the first elongated support member and an opposite end of the flexible sheet to the second elongated support member such that the flexible sheet extends between the two portions of the occupant seat, wrapping at least one of the one end of the flexible sheet at least partially around the first elongated support member and the opposite end of the flexible sheet at least partially around the second elongated support member to define a deployed width of the flexible sheet between the two portions of the occupant seat that is less than a fully extended width of the sheet defined between the one and the opposite end thereof.

In either embodiment, the step of wrapping at least one of the one end of the flexible sheet at least partially around the first elongated support member and the opposite end of the flexible sheet at least partially around the second elongated support member may comprise wrapping the one end of the flexible sheet around the first elongated support member a first number of times and/or wrapping the opposite end of the flexible sheet around the second elongated support member a second number of times. The first number of times may be the same as or different from the second number of times.

### BRIEF DESCRIPTION OF THE DRAWINGS

FIG. 1 is a side view of a portion of a motor vehicle interior showing one illustrative embodiment of a portable privacy barrier deployed between two separate side-by-side vehicle seats.

FIG. 2 is a side view of a portion of another motor vehicle interior showing another illustrative embodiment of a portable privacy barrier deployed between two portions of a single motor vehicle seat.

FIG. 3 is a front perspective view of the embodiment illustrated in FIG. 2 showing a portable privacy barrier deployed between two approximately equally sized portions of the vehicle seat such that the portable privacy barrier approximately bisects the vehicle seat.

FIG. 4 is a front perspective view of the motor vehicle seat of FIGS. 2 and 3 showing two portable privacy barriers deployed between three approximately equally sized portions of the vehicle seat.

FIG. 5 is a perspective view of the portable privacy barrier of either of FIGS. 1 and 2 disassembled and positioned in a storage bag sized for storage in the motor vehicle.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

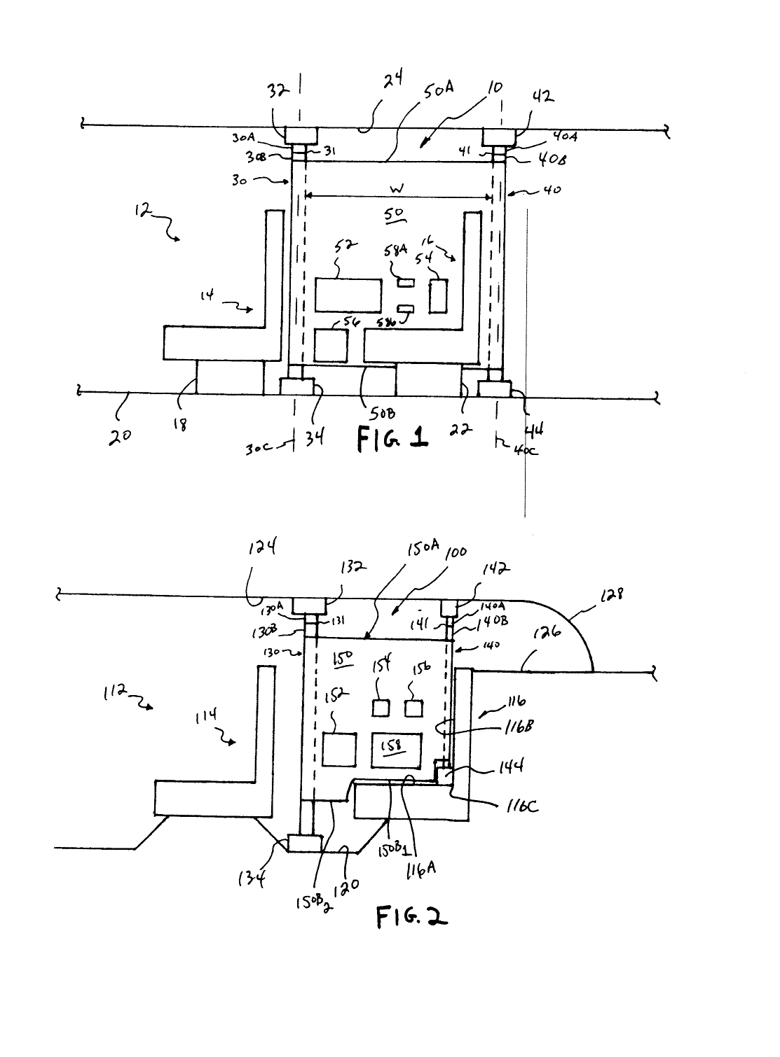

Referring now to FIG. 1, a side view is shown of a portion of an interior of a motor vehicle 12 including one illustrative embodiment of a portable privacy barrier 10 deployed between two separate side-by-side vehicle seats 22. It will be understood that in the embodiment illustrated in FIG. 1, the motor vehicle seat positioned in side-by-side relationship with the vehicle seat 22 is hidden from view by the vehicle seat 22 but is nevertheless present in the motor vehicle 12. Also shown in FIG. 1 is another vehicle seat 14 positioned in front of the vehicle seat 22, and although not shown in FIG. 1 yet another vehicle seat may be positioned in side-by-side relationship with the motor vehicle seat 14. In any case, the motor vehicle seat 14 is mounted to a seat base 18 which is mounted to the floor 20 of the motor vehicle 12, and the motor vehicle seat 16 is mounted to another seat base 22 which is also mounted to the floor 20 of the motor vehicle 12. The ceiling 24 of the motor vehicle 12 is illustrated above the vehicle seats 14 and 16.

In one embodiment, the motor vehicle 12 may be an automobile having at least two separate back seats positioned in side-by-side relationship, e.g., so-called captain's chairs or other conventional motor vehicle seats. Such vehicle seat configurations are common in, for examples, certain sport utility vehicles, vans, and the like. In alternative embodiments, the motor vehicle 12 may be a bus, coach, trolley, aircraft, watercraft or other conventional motor vehicle having two separate side-by-side seats. In either case the two separate side-by-side seats define a gap therebetween.

In the illustrated embodiment, the portable privacy barrier 10 includes two elongated support members 30 and 40, each configured to be removably secured to the motor vehicle 12 between the floor 20 and the ceiling 24. The phrase “removably secured” shall be understood to mean, for purposes of this document, that the support members 30 and 40 can be rigidly secured in place between the floor 20 and ceiling 24 when the barrier 10 is deployed as illustrated in FIG. 1, and can also be removed from between the floor 20 and ceiling 24 for repositioning and/or storage. The elongated support member 30 is shown removably secured between the floor 20 and ceiling 24 of the motor vehicle 12 between and generally in front of the two separate occupant seats 16, and the elongated support member 40 is shown removably secured between the floor 20 and ceiling 24 of the motor vehicle 12 between and generally in back of the two separate occupant seats 16. One end of a flexible sheet 50 is attached to the elongated support member 30 and an opposite end is attached to the elongated support member 40. The sheet 50 extends between the support members 30 and 40 and between the two separate occupant seats of the vehicle 12 to form the privacy barrier between the two side-by-side seats 16. Such positioning of the support members 30 and 40 is intended to provide a high degree of privacy between the side-by-side vehicle seats 16, although it will be understood that the particular positions of the support members 30 and 40 relative to the seats 16 may be varied to select an alternate degree of privacy.

The flexible sheet 50 defines a top end 50A which is illustratively positioned between tops of the two separate occupant seats 16 and the ceiling 24 of the motor vehicle 12. Such positioning allows light to pass over the sheet 50, although in other embodiments the top end 50A of the sheet 50 may extend up to or near the ceiling 24. The flexible sheet 50 further defines a bottom end 50B which is illustratively positioned between the seat portions of the vehicle seats 16 and the floor 20 of the motor vehicle 12. In other embodiments, the bottom end 50B of the sheet 50 may extend down to or near the floor 20.

In the embodiment illustrated in FIG. 1, the elongated support member 30 is provided in the form of two linear support members 30A and 30B defining a junction 31 between the two members 30A and 30B, and the elongated support member 40 is likewise provided in the form of two linear support members 40A and 40B defining a junction 41 between the two members 40A and 40B. One end of the linear support member 30A is received within the linear support member 30B, and the opposite end of the linear support member 30A is mounted to or otherwise received by a base member 32. The opposite end of the linear support member 30B is mounted to or otherwise received by another base member 34. Likewise, one end of the linear support member 40A is received within the linear support member 40B, and the opposite end of the linear support member 40A is mounted to or otherwise received by a base member 42, and the opposite end of the linear support member 40B is mounted to or otherwise received by another base member 44. In one embodiment, the linear support members 30A and 30B are illustratively threaded and/or otherwise rotatable relative to each other, as are the linear support members 40A and 40B, to increase and decrease the length of the elongated support members 30 and 40 respectively in a conventional manner. In alternative embodiments, the elongated support member 30 and/or 40 may alternatively include one or more conventional biasing members configured to normally bias the linear support members 30A and 30B, and/or the linear support members 40A and 40B, away from each other and toward the ceiling 24 and floor 20 respectively. It will be understood that either elongated support member 30 and 40 may alternatively be non-linear or include one or more non-linear portions, and that the junctions 31 and 41 may be located anywhere along the lengths of the elongated support members 30 and 40.

The base members 32, 34, 42 and 44 may, but need not, be adjustable toward and away from the elongated support members 30 and 40. If so, the elongated support members 30 and 40 may each be provided in the form of a single linear support member, and length adjustment may be accomplished by adjusting, e.g., rotating, one or more of the base members 32, 34, 42 and 44. Alternatively, the elongated support members 30 and 40 may be as described above with additional length adjustability being provided by the base members 32, 34, 42 and 44. In one alternative embodiment, for example, one or more of the base members 32, 34, 42 and 44 may include a biased receiving port that is sized to receive therein one end of an elongated support member 30, 40 and that is configured to normally bias a received elongated support member 30, 40 outwardly away from the base member 32, 34, 42 and 44. In this embodiment, the elongated support member 30, 40 is installed in the motor vehicle 12 by forcing the elongated support member 30, 40 into the biased port of the base member 32, 34, 42, 44, then positioning the elongated support member 30, 40 at desired locations relative to the ceiling 24 and floor 20, and then releasing the elongated support member 30, 40 such that the biased port forces the elongated support member 30, 40 toward the ceiling 24 or floor 20 and secures the elongated support member 30, 40 in place. In such embodiments, the elongated support members 30, 40 may be single, unitary support members or may be multiple part support members as described above for additional length adjustability. In any case, the elongated support members 30, 40 are positioned relative to the vehicle 12 as described above, and one or more of the foregoing length adjustment mechanisms is controlled to secure the elongated support members 30 and 40 in place.

The base members 32 and 42 each define a contact surface that contacts the ceiling 24 of the vehicle 12 when the elongated support members 30 and 40 are secured to the vehicle 12. These contact surfaces are illustratively sized to distribute forces applied by the elongated support members 30 and 40 to the ceiling 24 of the motor vehicle 12 over a sufficiently large area of the ceiling 24 to inhibit permanent deformation of the surface of the ceiling 24 by the elongated support members 30 and 40. In this way, the surface of the ceiling 24 will not become marred, marked or otherwise permanently damaged as a result of use of the privacy barrier 10. The base members 34 and 44 likewise each define contact surfaces that contact the floor 20 of the vehicle 12 when the elongated support members 30 and 40 are secured to the vehicle 12. These contact surfaces may, but need not, be sized as just described with respect to the base members 32 and 42. In some alternate embodiments, the base members 34 and 44 or the base members 32 and 42 may be omitted, and in other alternate embodiments all of the base members 32, 34, 42 and 44 may be omitted.

In the illustrated embodiment, the opposing ends of the flexible sheet 50 are attached at least partially along their lengths to the elongated support members 30 and 40. In one embodiment, for example, one end of the flexible sheet 50 is attached, e.g., sewed, glued or otherwise attached, along its length to itself to define a closed channel that is sized to receive therein the elongated support member 30. The opposite end of the flexible sheet 50 is likewise attached along its length to itself to define another closed channel that is sized to receive therein the elongated support member 40. In alternative embodiments, the ends of the sheet 50 may be affixed partially or fully along their lengths to the elongated support members 30 and 40 using any other conventional attachment structures and/or techniques.

Illustratively, the elongated support members 30 and 40 and the flexible sheet 50 are configured such that the sheet 50 may be wrapped at least partially around either or both of the support members 30 and 40 to adjust the effective width of the privacy barrier 10. In the embodiment illustrated in FIG. 1, for example, the flexible sheet 50 defines a deployed width, W, between the two elongated support members 30 and 40 which is less than the fully extended width, i.e., the full width, of the sheet 50 because it is at least partially wrapped around the elongated support members 30 and/or 40, e.g., by rotating the elongated support members 30 and 40 about their longitudinal axes 30C and 40C respectively. The flexible sheet 50 may is illustratively a synthetic fabric of any desired color or color combination, although it will be understood that the flexible sheet 50 may alternatively be or include one or more non-fabric materials. Examples of suitable materials for the flexible sheet 50 include, but should not be limited to, natural fabric, nylon, canvas, polypropylene, vinyl or the like, or a combination of any one or more of the foregoing. In any case, the opacity of the material used for the sheet 50 will generally be selected to achieve a desired level of visual privacy.

The flexible sheet 50 may include one or more pockets, e.g., 52, 54 and/or 56, and/or may include one or more straps, e.g., 58A and 58B, on either or both sides of the sheet 50. The pockets 52, 54 and/or 56 may be used to store various items, examples of which include, but should not be limited to, books, paper, pencils, electronic devices, food, refuse and beverages. The straps 58A and 58B may be used, for example, to support a beverage holding device or other support device. As another example, multiple rows and columns of straps may be provided on either or both sides of the sheet 50 which are sized to accommodate one or more legs extending from one end of a table having an opposite end from which one or more legs also extends. Such a table may be supported at one end by the sheet 50 and at the opposite end by, for example, an arm rest of the adjacent vehicle door. As it relates to the type, number and/or arrangement of pockets and/or straps affixed to or integral with either or both sides of the flexible sheet 50, the material used for the flexible sheet 50 will typically be selected to have sufficient strength to support such pockets and/or straps and items stored therein and/or items supported thereby. This disclosure contemplates embodiments in which the flexible sheet 50 may be reinforced for the purpose of supporting such one or more pockets and/or straps and items stored therein and/or items supported thereby.

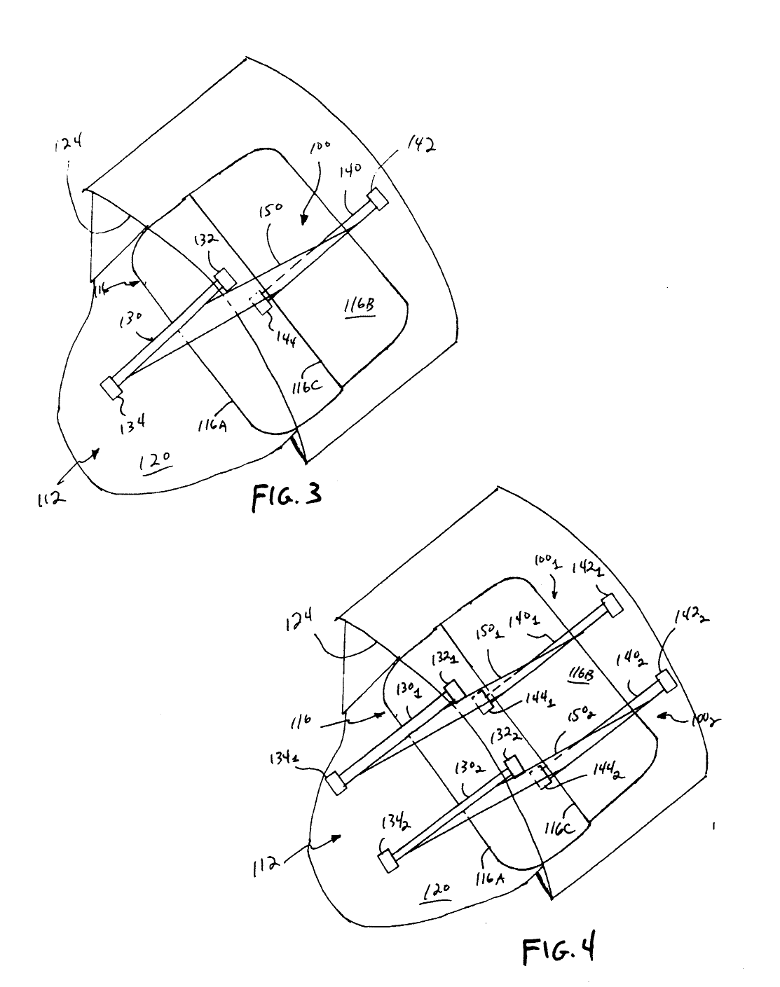

Referring now to FIG. 2, a side view is shown of a portion of an interior of another motor vehicle 112 including another illustrative embodiment of a portable privacy barrier 100 deployed between two portions of a single, multiple-occupant motor vehicle seat 116. It will be understood that the reference numbers used in FIG. 2 generally track those of FIG. 1 by a factor of 100, and except as noted below, similarly numbered structures are as described with respect to FIG. 1. In the embodiment illustrated in FIG. 2, the motor vehicle 112 has at least one front seat 114 and a single, multiple occupant seat 116 positioned behind the front seat 114. The single, multiple occupant seat 116, may be a conventional bench-style seat, and has a seat bottom 116A mounted to the floor 120 of the vehicle 112, a seat back 116B extending upwardly from the seat bottom and a bight 116C defined between the seat bottom 116A and seat back 116B. A rear portion of the vehicle forms a deck 126, which may be bounded by a rear window 128. Such vehicle seat configurations are common in, for examples, passenger cars. In alternative embodiments, the motor vehicle 112 may be any vehicle having a single, multiple occupant seat such as a bus, coach, trolley, aircraft, watercraft or other conventional motor vehicle.

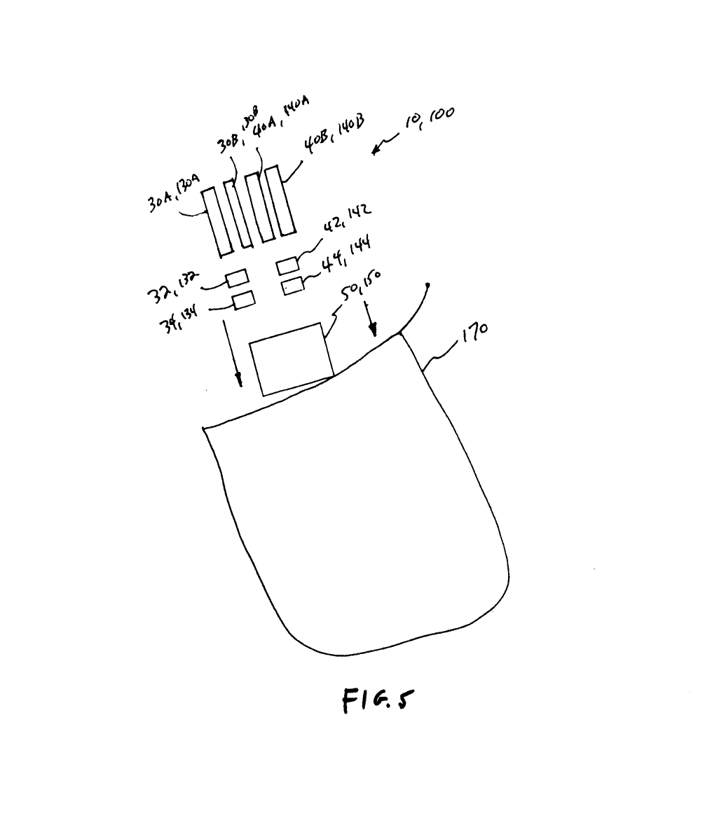

The privacy barrier 100 is identical in many respects to the privacy barrier 10 illustrated and described hereinabove with respect to FIG. 1. The embodiments differ in that the elongated support member 140 is secured not between the ceiling 124 and the floor 120 of the motor vehicle 112, but rather between the ceiling 124 and the seat bottom 116A of the vehicle seat 116. The privacy barrier 100 thus partitions the vehicle seat 116 into two separate portions as illustrated in FIG. 3. Illustratively, the base member 144 is positioned at or adjacent to the bight 116C of the vehicle seat 116 so that the privacy barrier 100 is positioned at or against the seat back 116B. In embodiments in which the seat back 116A tilts rearwardly, an additional section of sheet 150 may be attached to the elongated support member 140 and secured to the deck 126, e.g., via a conventional latch carried by the deck 126. In any case, the bottom end of the sheet 150 is formed in two sections; one 150B1 that is positioned at or near the occupant support surface of the seat bottom 116A, and another 150B2 that extends toward the floor 120 of the motor vehicle 112 in front of the seat bottom 116A. In alternate embodiments, the section 150B2 is omitted, and the section 150B1 extends across the occupant support surface of the seat bottom 116A to the elongated support member 130. The flexible sheet 150 is thus attached to and between the elongated support member 130 and the elongated support member 140 across the single, multiple occupant motor vehicle seat 116 to provide a privacy barrier 100 between two portions of the single, multiple occupant motor vehicle seat 116. It will be understood that multiple privacy barriers may be extended across the single, multiple occupant motor vehicle seat 116 to provide a plurality of privacy zones. As illustrated in FIG. 4, for example, two such privacy barriers 1001 and 1002 are provided to partition the single, multiple occupant motor vehicle seat 116 into three separate privacy zones.

While the various embodiments shown in FIGS. 1-4 illustrate a portable privacy barrier 10, 100 that may be used with an existing motor vehicle, this disclosure contemplates embodiments in which the motor vehicle may be designed to include or accommodate a privacy barrier 10, 100. In such embodiments, for example, the ceiling 24, 124 of the motor vehicle 12, 112 may define attachment structures configured for selective attachment to the top ends of the elongated support members 30, 40 or 130,140, and the floor 20, 120 of the motor vehicle 12, 112 may likewise define attachment structures configured for selective attachment to the bottom ends of the elongated support members 30, 40 or 130,140. The elongated support members 30, 40 or 130, 140 may, in such embodiments may be single, unitary elongated structures or multiple-piece structures. The flexible sheet 50, 150 may, in such embodiments, define a sufficient width which, when attached to the elongated support members 30, 40 or 130, 140, allow the elongated support member 30, 40 or 130, 140 to align with the attachment structures defined in the ceiling 24, 124 and floor 20, 120 for attachment thereto.

Referring now to FIG. 5, it is contemplated that the privacy barrier 10, 100 may be disassembled for ease of storage. A storage bag 170 may be provided, and the disassembled privacy barrier 10, 100 may be inserted into the bag 170 for storage. The storage bag 170 may be sized for storage within the motor vehicle 12, 112 when not in use.

A method is also provided for forming a privacy barrier of the type illustrated and described herein in a motor vehicle. For example, in a motor vehicle having two separate occupant seats positioned side-by-side with a gap defined therebetween as illustrated in FIG. 1, a method of forming a privacy barrier between the two separate occupant seats may comprise securing a first elongated support member, e.g., 30, between a floor and a ceiling of the motor vehicle fore of the two separate occupant seats, securing a second elongated support member, e.g., 40, between the floor 20 and the ceiling 24 of the motor vehicle aft of the two separate occupant seats, attaching one end of a flexible sheet 50 to the first elongated support member 30 and an opposite end of the flexible sheet 50 to the second elongated support member 40 such that the flexible sheet 50 extends through the gap between the two separate occupant seats as illustrated in FIG. 1, wrapping at least one of the one end of the flexible sheet 50 at least partially around the first elongated support member 30 and the opposite end of the flexible sheet 50 at least partially around the second elongated support member 40 to define a deployed width of the flexible sheet 50 between the two separate occupant seats that is less than a fully extended width of the sheet defined between the one and the opposite end thereof.

In a motor vehicle having a single, multiple occupant seat 116 having a seat back 116B, a seat bottom 116A and a bight 116C defined between the seat back 1168 and the seat bottom 116A as illustrated in FIGS. 2-4, a method of forming a privacy barrier between two portions of the occupant seat may comprise securing a first elongated support member, e.g., 130, between a floor 120 and a ceiling 124 of the motor vehicle fore of the occupant seat, securing a second elongated support member, e.g., 140, between the ceiling 124 of the motor vehicle and the seat bottom 116A of the occupant seat adjacent to the bight 116C, attaching one end of a flexible sheet 150 to the first elongated support member 130 and an opposite end of the flexible sheet 150 to the second elongated support member 140 such that the flexible sheet 150 extends between the two portions of the occupant seat 116, wrapping at least one of the one end of the flexible sheet 150 at least partially around the first elongated support member 130 and the opposite end of the flexible sheet 150 at least partially around the second elongated support member 140 to define a deployed width of the flexible sheet 150 between the two portions of the occupant seat 116 that is less than a fully extended width of the sheet defined between the one and the opposite end thereof.

In either embodiment, the step of wrapping at least one of the one end of the flexible sheet at least partially around the first elongated support member and the opposite end of the flexible sheet at least partially around the second elongated support member may comprise wrapping the one end of the flexible sheet around the first elongated support member a first number of times and/or wrapping the opposite end of the flexible sheet around the second elongated support member a second number of times. The first number of times may be the same as or different from the second number of times.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A portable privacy barrier for a motor vehicle having two separate occupant seats positioned side-by-side with a gap defined therebetween, the privacy barrier comprising:
a first elongated support member configured to be removably secured between a floor and a ceiling of the motor vehicle fore of the two separate occupant seats,
a second elongated support member configured to be removably secured between the floor and the ceiling of the motor vehicle aft of the two separate occupant seats, and
a flexible sheet having a first end attached to the first elongated support member and a second opposite end attached to the second elongated support member, the flexible sheet extending between the first and second elongated support members and through the gap between the two separate occupant seats to provide a privacy barrier between the two separate occupant seats.

2. The portable privacy barrier of claim 1 wherein the flexible sheet defines a fully extended width between the first and second ends thereof,
and wherein the flexible sheet and the first and second elongated support members are configured such that the flexible sheet wraps at least partially around either or both of the first and second elongated support members any number of times to define a deployed width of the flexible sheet between the first and second elongated support members and between the two separate occupant seats that is less than the fully extended width.

3. The portable privacy barrier of claim 1 wherein the flexible sheet defines a top end extending between the first and second ends of the flexible, the top end positioned between tops of the two separate occupant seats and the ceiling of the motor vehicle.

4. The portable privacy barrier of claim 1 wherein the flexible sheet defines a top end extending between the first and second ends of the flexible sheet, the top end positioned at or near the ceiling of the motor vehicle.

5. The portable privacy barrier of claim 1 wherein the flexible sheet defines a bottom end extending between the first and second ends of the flexible sheet, the bottom end positioned between seat portions of the two separate occupant seats and the floor of the motor vehicle.

6. The portable privacy barrier of claims 1 wherein the flexible sheet defines a bottom end extending between the first and second ends of the flexible sheet, the bottom end positioned at or near the floor of the motor vehicle.

7. The portable privacy barrier of claim 1 wherein the first end of the flexible sheet is attached to the first elongated support member at least partially along a length of the first elongated support member, and the second end of the flexible sheet is attached to the second elongated support member at least partially along a length of the second elongated support member.

8. The portable privacy barrier of claim 7 wherein the first end of the flexible defines a first closed channel at least partially along the length of the first end of the flexible sheet, the first closed channel sized to receive therein the first elongated support member,
and wherein the second end of the flexible sheet defines a second closed channel at least partially along the length of the second end of the flexible sheet, the second closed channel sized to receive therein the second elongated support member.

9. The portable privacy barrier of claim 1 wherein the first elongated support member comprises a first linear member and a second linear member received within the first linear member, the first and second linear members movable relative to each other to modify a length of the first elongated support member,
and wherein the second elongated support member comprises a third linear member and a fourth linear member received within the third linear member, the third and fourth linear members movable relative to each other to modify a length of the second elongated support member.

10. The portable privacy barrier of claim 1 further comprising:
a first base positioned between a top end of the first elongated support member and the ceiling of the motor vehicle, the first base having a first contact surface that contacts the ceiling of the motor vehicle, the first contact surface sized to distribute a force applied by the first elongated support member to the ceiling of the motor vehicle over a sufficiently large area of the ceiling of the motor vehicle to inhibit permanent deformation of a surface of the ceiling by the first elongated support member,
and a second base positioned between a top end of the second elongated support member and the ceiling of the motor vehicle, the second base having a second contact surface that contacts the ceiling of the motor vehicle, the second contact surface sized to distribute a force applied by the second elongated support member to the ceiling of the motor vehicle over a sufficiently large area of the ceiling of the motor vehicle to inhibit permanent deformation of a surface of the ceiling by the second elongated support member.

11. The portable privacy barrier of claim 1 wherein the flexible sheet comprises at least one pocket on at least one side thereof.

12. The portable privacy barrier of claim 1 wherein the flexible sheet comprises one or more straps affixed to at least one side thereof.

13. The portable privacy barrier of any of claim 1 wherein the first and second elongated support members are each configured to be disassembled,
and further comprising a storage bag sized to receive therein the disassembled first and second elongated support members and the flexible sheet, the storage bag sized for storage within the motor vehicle with the disassembled first and second elongated support members and the flexible sheet stored therein.

14. A portable privacy barrier for a single, multiple occupant seat of a motor vehicle, the occupant seat having a seat back, a seat bottom and a bight defined between the seat back and the seat bottom, the privacy barrier comprising:
a first elongated support member configured to be removably secured between a floor and a ceiling of the motor vehicle fore of the single, multiple occupant seat,
a second elongated support member configured to be removably secured between the ceiling of the motor vehicle and the seat bottom adjacent to the bight, and
a flexible sheet having a first end attached to the first elongated support member and a second opposite end attached to the second elongated support member, the flexible sheet extending between the first and second elongated support members and across the single, multiple occupant motor vehicle seat to provide a privacy barrier between two portions of the single, multiple occupant motor vehicle seat.

15. The portable privacy barrier of claim 14 wherein the flexible sheet defines a fully extended width between the first and second ends thereof,
and wherein the flexible sheet and the first and second elongated support members are configured such that the flexible sheet wraps at least partially around either or both of the first and second elongated support members any number of times to define a deployed width of the flexible sheet between the first and second elongated support members and across the single, multiple occupant motor vehicle seat that is less than the fully extended width.

16. The portable privacy barrier of claim 14 wherein the flexible sheet defines a bottom end extending between the first and second ends of the flexible sheet, the bottom end of the flexible sheet comprising a first portion positioned at or near an occupant support surface of the seat bottom and a second portion positioned at or near the floor of the motor vehicle fore of the single, multiple occupant vehicle seat.

17. The portable privacy barrier of claim 14 wherein the first elongated support member comprises a first linear member and a second linear member received within the first linear member, the first and second linear members movable relative to each other to modify a length of the first elongated support member,
and wherein the second elongated support member comprises a third linear member and a fourth linear member received within the third linear member, the third and fourth linear members movable relative to each other to modify a length of the second elongated support member.

18. The portable privacy barrier of claims 14 further comprising:
a first base positioned between a top end of the first elongated support member and the ceiling of the motor vehicle, the first base having a first contact surface that contacts the ceiling of the motor vehicle, the first contact surface sized to distribute a force applied by the first elongated support member to the ceiling of the motor vehicle over a sufficiently large area of the ceiling of the motor vehicle to inhibit permanent deformation of a surface of the ceiling by the first elongated support member,
and a second base positioned between a top end of the second elongated support member and the ceiling of the motor vehicle, the second base having a second contact surface that contacts the ceiling of the motor vehicle, the second contact surface sized to distribute a force applied by the second elongated support member to the ceiling of the motor vehicle over a sufficiently large area of the ceiling of the motor vehicle to inhibit permanent deformation of a surface of the ceiling by the second elongated support member.

19. The portable privacy barrier of claim 14 wherein the flexible sheet comprises one of at least one pocket on and at least one strap affixed to at least one side thereof.

20. The portable privacy barrier of claims 14 wherein the flexible sheet comprises one or more straps affixed to at least one side thereof.
